(19) United States
(12) Patent Application Publication
(10) Pub. No.: US 2026/0369884 A1
(43) Pub. Date: Nov. 19, 2026

(54) ANTENNA ARCHITECTURES FOR AR CAPABLE WEARABLE DEVICES

(71) Applicant: Snap Inc., Santa Monica, CA (US)

(72) Inventors: Catlynn Duc Zarquan Nguyen, San Francisco, CA (US); Ugur Olgun, Marina Del Rey, CA (US); Brandon R Collins-Smoot, San Jose, CA (US)

(21) Appl. No.: 19/669,840

(22) Filed: May 6, 2026

Related U.S. Application Data
(60) Provisional application No. 63/805,476, filed on May 14, 2025.

(51) Int. Cl. H01Q 5/307; H01Q 1/27; H01Q 7/00; H01Q 9/16

(52) U.S. Cl. CPC H01Q 5/307; H01Q 1/273; H01Q 7/00; H01Q 9/16

(57) ABSTRACT

A wearable device may include an eyewear frame defining one or more optical element holders for holding respective optical elements within view of a user when the wearable device is worn. A wearable device may include a pair of temples connected to the eyewear frame for supporting the eyewear frame in position within view of the user when the wearable device is worn. A wearable device may include a battery assembly carried by at least one of the eyewear frame or by one of the pair of temples. A wearable device may include a hybrid antenna assembly electrically coupled to the battery assembly, the hybrid antenna assembly having a conductive trace with a first portion forming a loop antenna section and a second portion forming a dipole antenna section, wherein the dipole antenna section is electrically connected to the loop antenna section at a tap point.

### PRIORIY CLAIM

This application claims the benefit of U.S. Provisional Application No. 63/805,476, filed on May 14, 2025, which is hereby incorporated by reference in its entirety.

### BACKGROUND

Wearable augmented reality (AR) devices present unique challenges for antenna design. These devices must balance multiple competing requirements: efficient wireless communication across multiple frequency bands, minimal physical size, aesthetic considerations, and power efficiency. Traditional antenna designs often require substantial dedicated space, which conflicts with the compact form factor demanded by modern wearable devices. With wearable devices, available space for antenna systems is often at a minimum. Adding to design challenges, modern wireless communication standards necessitate an antenna architecture with multiple antenna elements, each of which has to be electrically isolated from one another to ensure little to no correlation between the different antenna elements. These antenna elements should be capable of simultaneous operation with high radiation efficiency on wide and far apart frequency bands.

In many modern consumer electronics, antenna design is frequently compromised for aesthetic or weight considerations, resulting in limited electrical volume. This constraint forces antenna engineers to develop more innovative approaches to maintain efficiency and satisfy radiation requirements. The increasing complexity of AR wearable devices, with their requirements for multiple wireless communication standards (such as WiFi 6E operating at 2.4 GHz, 5 GHz, and 6 GHz bands), demands antenna designs that can efficiently operate across these frequencies without compromising the device's form factor or functionality.

### BRIEF DESCRIPTION OF THE DRAWINGS

The appended drawings merely illustrate a selection of examples of the present disclosure and cannot be considered as limiting its scope. To facilitate collation of numbered items in the description to the drawings, the first digit of each numbered item corresponds to the figure in which that item first appears. In the drawings:

FIG. 1 is a perspective view of an electronics enabled eyewear device having a frame and a pair of temples, according to an example.

FIG. 2 is a perspective view of a portion of the eyewear device of FIG. 1 with a covering removed on one side of one of the pair of temples to show various electronic components, according to an exemplary example.

FIG. 3 is a perspective view of the eyewear device of FIG. 2 in a worn position on a user with portions of the pair of temples removed to show two battery assemblies and at least two hybrid antenna assemblies, according to an exemplary example.

FIG. 4 is a schematic view of another example of an eyewear device with a similar construction to that of FIGS. 2 and 3 that can have a battery assembly and a hybrid antenna assembly carried by each of the pair of temples according to an exemplary example.

FIG. 5 is a schematic view of a hybrid antenna assembly formed by components of one of a pair of temples including the battery assembly, according to an exemplary example.

FIG. 6 is a perspective view of a posterior portion of one of the pair of temples with an over-mold, cover, housing or the like removed to illustrate various components including the battery assembly, the hybrid antenna assembly and additional components, according to an exemplary example.

FIGS. 7-11 are enlarged perspective views of the posterior portion of the temple shown in FIG. 6 from various perspectives, according to an exemplary example.

FIG. 12 is an enlarged perspective view of the posterior portion of the temple from another side of the temple and battery assembly additionally showing a transceiver electrically connected to a housing of the battery assembly, according to an exemplary example.

FIG. 13 shows the transceiver of FIG. 12 and other aspects of the posterior portion of the temple with the transceiver covered by an element, according to an exemplary example.

FIG. 14 shows a chart of a voltage standing wave ratio (VSWR) of the hybrid antenna assembly shown in FIGS. 6-13 when the hybrid antenna assembly is designed as to operate as a WiFi 6E antenna, according to an exemplary example.

FIG. 15 is a flow chart of a method of forming a multiband hybrid antenna assembly for a wearable device, according to an exemplary example.

### DETAILED DESCRIPTION

The subject matter disclosed herein generally relates to a wearable device that can be AR enabled, and more specifically to electronics-enabled eyewear (sometimes referred to simply as a wearable device, spectacles or glasses herein) with wireless communication enabled onboard electronic components facilitated by one or more hybrid antennas (sometimes referred to herein as an antenna assembly, antenna system or simply as antenna(s)) and other electronics components such as a battery assembly, a transceiver, a chipset, etc. Additionally, the eyewear can have multiple antennas. These multiple antennas can be carried by one or both the temple(s), or a combination of the temple(s) and the frame of the eyewear, for example.

According to one example, the wearable device features a battery assembly carried by at least one of the temples. The battery assembly can be positioned at the posterior (rear) end of the temple behind the user's ear when worn. This strategic placement of the battery helps balance the weight of the display components located at the front of the wearable device. The hybrid antenna assembly can be electrically coupled to the battery assembly. The hybrid antenna assembly can include a conductive trace with a first portion forming a loop antenna section and a second portion forming a dipole antenna section. The dipole antenna section can be electrically connected to the loop antenna section at a location called a tap point.

Previous attempts to combine dipole and loop antenna characteristics include designs like the helical antenna and the hybrid antenna disclosed in US Patent 11,063,338, the entire disclosure of which is incorporated herein in its entirety. The latter design leveraged the eyewear platform by using the front frame for antenna placement, with the loop antenna termination point coinciding with the launch of the dipole mode. While effective, this approach had drawbacks, particularly in AR devices where the front frame houses display optics, cameras, LED systems, and sensors. Placing antennas in this location could create coexistence issues with these systems and reduced the structural integrity of the frame needed for precise display calibration. These challenges have driven the need for a new approach to antenna design for AR wearable devices such as disclosed herein. The present approach can maintain the benefits of hybrid radiation mechanisms while addressing the spatial and functional constraints of modern smart glasses.

Increasing complexity of AR wearable devices, with their requirements for multiple wireless communication standards (such as WiFi 6E operating at 2.4 GHz, 5 GHz, and 6 GHz bands), demands antenna designs that can efficiently operate across these frequencies without compromising the device's form factor or functionality. This necessitates an approach such as disclosed herein that can leverage existing structural elements of the device while providing the required multiband performance and radiation efficiency. Thus, the present application discloses a multiband hybrid antenna that utilizes a housing of the battery assembly for electrical connection pathway. Such an arrangement can help in addressing these challenges, enabling efficient wireless communication while maintaining the compact and balanced design essential for wearable AR devices.

The antenna systems disclosed can include the transceiver configured for wireless communication. The antenna system can be connected to the transceiver and configured to receive (and transmit) various signals. The antenna system may further include electronics configured to provide frequency-domain discrimination. However, it is contemplated that the antenna system disclosed can be configured (e.g., sized, constructed and/or shaped) for two or more wireless communication (operation) modalities according to some examples. Thus, the antenna system can be configured to receive and/or transmit data at approved frequency ranges for 3G, 4G, 5G, 6G, etc. communication (generally between 699 MHz to 2200 MHz range), and can be configured to cover even wider frequencies if desired. Specific cellular bands supported can include n12, n13, n5, n8, n1, n2, n3, n66, etc. The antenna systems can be configured to receive and/or transmit data at other approved frequency ranges for Global Positioning System (GPS), such as bands L1 to L5 (e.g., between 1.2 GHz range and 1.6 GHz range), BLUETOOTH® (e.g., 2.4 GHz) and/or Wi-Fi (e.g., 2.4, 5 or 6 GHz), for example. However, it is contemplated that the antenna systems can operate at any desired range of microwave frequencies (from 300 MHz to 30 GHz).

As used herein an active antenna element (or simply active element) is an actively driven antenna element that is a conductor for the antenna that radiates/receives EM signals. An antenna is a device used to transmit and/or receive radio waves. It converts electric currents into radio waves and vice versa. An antenna system is a plurality of antennas. An antenna provides the interface between radio waves propagating through space and electric currents moving in one or more metal conductors. In general, an antenna refers to the entire arrangement of metal conductors used for radiating or receiving radio waves. It can take on many different shapes and configurations. An antenna element (or active antenna element) is a basic building block of an antenna. It is a single radiating piece or section of an antenna. Antennas are often composed of multiple antenna elements working together to transmit/receive signals. An antenna element is a component(s) or part(s) of the overall antenna structure. The term “element” refers to one or more radiating pieces, whereas “antenna” refers more broadly to the overall system of components.

It will be understood that the antenna systems disclosed herein provide improved signal reception, improved radiation efficiency, improved polarization diversity, and other benefits when compared to existing antenna systems for handheld or wearable devices while being integrated effectively into a constricted space in existing electronically enabled eyewear design.

According to one example the antenna system can include a first segment length (L1) and a second segment length (L2) that together with the battery assembly are configured to operate in a loop antenna mode. The second portion includes a third segment length (L3) that extends from the tap point on the loop antenna section, wherein the third segment length in combination with the first segment length are configured to operate in a dipole antenna mode.

Physical dimensions of these segments can greatly influence the antenna’s performance. In some examples, at least one of the first segment length or the second segment length has substantially the same physical length as the third segment length. The lengths of these segments determine the frequency of operation, while the width between the segments (e.g., indicated as W1 and W2 in some examples) determines the bandwidth capability of the hybrid antenna assembly. However, other length ratios and other widths are contemplated and those lengths provided here in are merely exemplary.

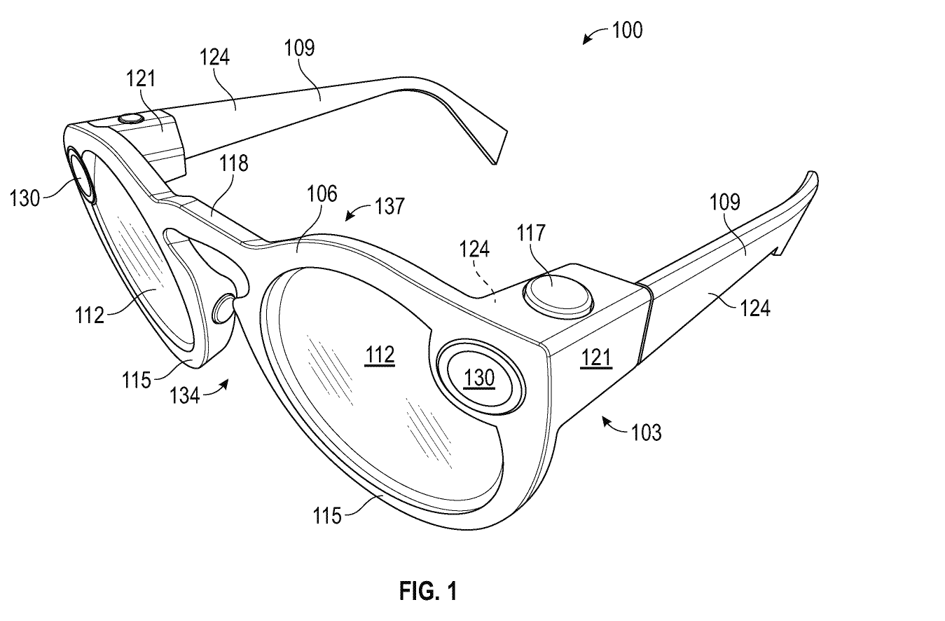

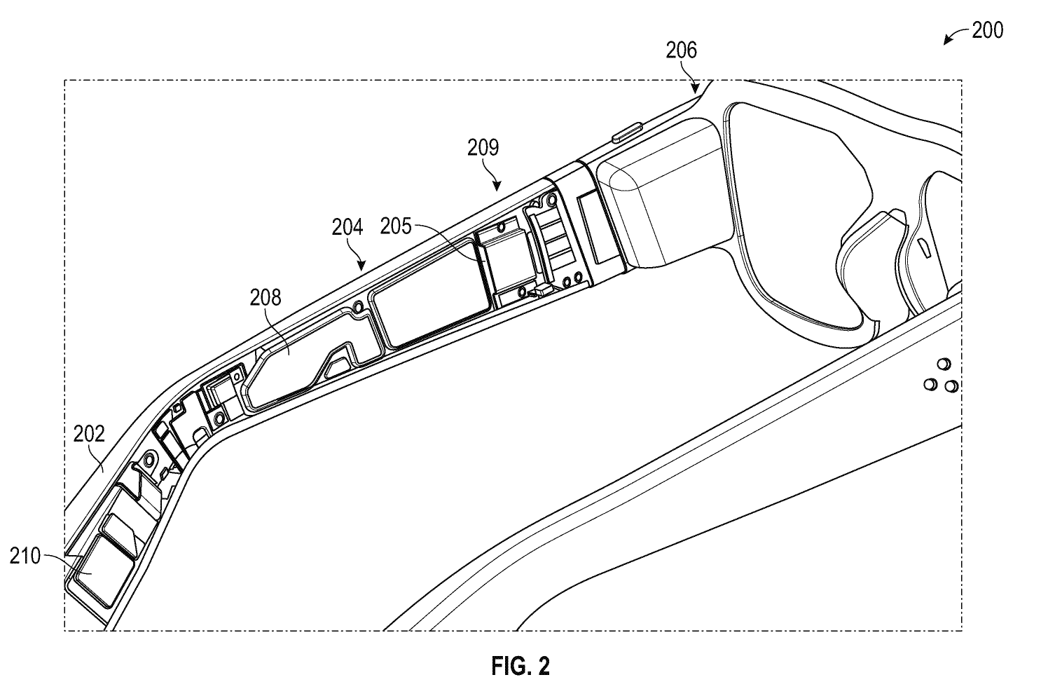

Various examples of an antenna system according to this disclosure will be described below with reference to an electronic device in the example form of an eyewear device that incorporates one or more of the disclosed antennas. Such eyewear device may include one or more cameras, indicator lights, memory, control circuitry, battery elements, and wireless communication circuitry among other components. An example of such an eyewear device in which different examples of the antennas can be incorporated will first be described with reference to FIG. 1, after which a series of different examples example of antennas incorporating the different respective examples will be described with reference to FIGS. 2-11.

FIG. 1 shows an oblique front view of an electronic device in the example form of an electronics enabled eyewear device 100, also referred to as a pair of smart glasses. The eyewear device 100 includes a body 103 comprising a front piece or frame 106 and a pair of temples 109 moveably connected to the frame 106 for supporting the frame 106 in position on a user's face when the eyewear device 100 is worn. The frame 106 can be made from any suitable material such as plastics, composite, or metal, including any suitable shape memory alloy.

The eyewear device 100 has a pair of optical elements in the example form of a pair of optical lenses 112 held by corresponding optical element holders or lens holders in the form of a pair of lens rims 115 forming part of the frame 106. According to one example, the optical lenses 112 can be constructed of a chemically-strengthened lithium aluminosilicate (LAS) glass and can be displays configured to provide the user an augmented reality. The rims 115 are connected by a bridge 118. In other examples, of one or both of the optical elements can be a display, a display assembly, or a lens and display combination. The eyewear device 100 can, in such examples, comprise a virtual reality display or a see through augmented reality display.

The frame 106 includes a pair of end pieces (or chunks) 121 defining lateral end portions of the frame 106. In this example, at least some electronics components are housed in one or both of the end pieces 121. In some examples, the frame 106 can be formed of a single piece of material, so as to have a unitary or monolithic construction.

The temples 109 are coupled to the respective end pieces 121. In this example, the temples 109 are coupled to the frame 106 by respective hinges (articulating joint) so as to be hingedly movable between a wearable mode (as shown in FIG. 1) and a collapsed mode in which the temples 109 are pivoted towards the frame 106 to lie substantially flat against it. In other examples, the temples 109 can be coupled to the frame 106 by any suitable means. Each of the temples 109 includes a front portion that is coupled to the frame 106 and a suitable rear portion for coupling to the ear of the user, such as the curved earpiece illustrated in the example of FIG. 1. The temples 109 can be made from any suitable material(s) such as plastics, composite, and/or metal.

In this description, directional terms such as front, back, forwards, rearwards, outwards and inwards are to be understood with reference to a direction of view of a user when the eyewear device 100 is worn. Thus, the frame 106 has an outwardly directed front side 134 facing away from the user when worn, and an opposite inwardly directed rear side 137 side facing towards the user when the eyewear device 100 is worn. Similarly, the terms horizontal and vertical as used in this description with reference to different features of the eyewear device 100 are to be understood as corresponding to the orientation of the eyewear device 100 when it is level on the face of a user looking forwards. A horizontal or lateral direction of the eyewear device 100 thus extends more or less between the end pieces 121, while a vertical or upright direction of the eyewear device 100 extends transversely to the horizontal direction, such that the lenses 112 can be said to have a more or less vertical or upright orientation.

The eyewear device 100 has onboard electronic components 124 (sometimes called just electronics or components herein) including any one or combination of an antenna(s) (discussed further subsequently), a camera, a microphone, a speaker, a battery, a display device, a computing device, such as a computer, which can, in different examples, be of any suitable type so as to be carried by the eyewear body 103. In some examples, various components comprising the onboard electronics 124 are at least partially housed in one or both of the temples 109. Additionally, various components of the onboard electronics 124 are housed in the lateral end pieces 121 of the frame 106. As discussed above, the onboard electronics 124 includes one or more processors with memory, wireless communication circuitry, and a power source (this example being a rechargeable battery, e.g. a lithium-ion battery or solid state battery). The onboard electronics 124 comprises low-power, high-speed circuitry, and, in some examples, a display processor. Various examples may include these elements in different configurations or integrated together in different ways. As further discussed, the antenna systems described herein may be housed in one or both of the temples 109 and/or additionally in the frame 106. Thus, for example, certain electronics components such as the transceiver may in some examples be housed in the temple 109 as further discussed and illustrated subsequently.

As mentioned, the onboard electronics 124 includes a rechargeable battery. In some examples, the battery is disposed in one or both of the temples 109 such as near or at a posterior tip of one of the temples 109 and is electrically coupled to the remainder of the onboard electronics 124.

The eyewear device 100 is camera-enabled, in this example comprising a camera 130 mounted in one of the end pieces 121 and facing forwards so as to be aligned more or less with the direction of view of a wearer of the eyewear device 100. The camera 130 is configured to capture digital still as well as digital video content. Operation of the camera 130 is controlled by a camera controller provided by the onboard electronics 124, image data representative of images or video captured by the camera 130 being temporarily stored on a memory forming part of the onboard electronics 124. In some examples, the eyewear device 100 can have a pair of cameras 130, e.g. housed by the respective end pieces 121.

The eyewear device 100 further includes one or more input and output devices permitting communication with and control of the camera 130. In particular, the eyewear device 100 includes one or more input mechanisms for enabling user control of one or more functions of the eyewear device 100. In this example, the input mechanism comprises a button 117 mounted on the frame 106 so as to be accessible on top of one of the end pieces 121 for pressing by the user.

The eyewear device 100 is, in this example, configured for wireless communication with external electronic components or devices, to which end the onboard electronics 124 is connected to one or more antennas integrated in the body 103 of the eyewear device 100.

Eyewear device 100 including optical lenses 112 (sometimes called displays herein) can have a construction as described variously in U.S. Patent Numbers United States Patent Nos. U.S. 9,726,904, titled EYEWEAR WITH CONDUCTIVE TEMPLE JOINT (filing date, Sep. 29, 2015); U.S. 9,482,882 titled EYEWEAR HAVING SELECTIVELY EXPOSABLE FEATURE (filed Apr. 15, 2015); and U.S. 9,482,883 titled EYEWEAR HAVING LINKAGE ASSEMBLY BETWEEN A TEMPLE AND A FRAME filed (Apr. 15, 2015), U.S. 10,877,293, titled EYEWEAR DEVICE LENS RETENTION MECHANISM, (filed Jan. 18, 2018), U.S. 11,063,338, titled HYBRID ANTENNA SYSTEM FOR WEARABLE DEVICES, (filed Jan. 24, 2019), U.S. 10,534,203, titled NEAR-FIELD ANTENNA FOR EYEWEAR, (filed Jul. 31, 2017), US Patent Application Publication Nos. 2019/0229395 and 2019/0033622, the contents of all of which are incorporated herein in their entirety.

FIG. 2 shows a perspective view of one of the temples 209 of an wearable device 200 (e.g. eyewear), which can be constructed in a manner similar to the eyewear device 100 of FIG. 1. The temple 209 includes a cover 202 (partially removed in FIG. 2 to show internal components), electronics 204 such as a processor 205, speaker 208 and a battery assembly 210. A frame 206 of the eyewear device 100 is also partially illustrated in FIG. 2.

Temple 209 has an elongate length extending from the frame 206 in a pivotable or other moveable manner. FIG. 2 shows the battery assembly 210 positioned at the posterior rear of the temple 209 opposite the frame 206. Such arrangement can help balance the weight of a display components located at the frame 206. The cover 202 (partially removed in FIG. 2) forms the outer shell of the temple 209. The electronics 204 such as the speaker 208 can be arranged along the elongate length of the temple 209. The speaker 208 can be positioned so as to be generally aligned with the user's ear when the device is worn. The processor 205 and other electronics 204 can be located forward and rearward of the speaker 208. The processor 205 can be configured for controlling various functions of the wearable device 200. Electronics 204 can be housed within the temple 209 and/or temple 209.

FIG. 2 with the portion of the cover 202 removed reveals the internal architecture of the temple 209, showing how the various components are arranged longitudinally to fit within the compact form factor of the temple 209 to allow the wearable device 200 to operate as an AR or other electronically enabled device. The cover 202 can be a plastic or other rigid material such as cellulosic plastic (e.g., cellulosic acetate), an eco-plastic material, a thermoplastic material, or the like. The cover 202 can be an over-mold that encloses, embeds or otherwise encases the electronics 204 and/or other structural components. The cover 202 can form an outer cap for the temple 209 and can extend longitudinally along a length of the temple 209 from an articulated joint toward a second longitudinal end (posterior tip) of the temple 209 where the battery assembly 210 is carried. As illustrated in FIG. 2, the battery assembly 210 and the other electronics 204 are carried by the temple 209. However, some of the electronics 204 including the battery assembly and antenna(s) discussed can be carried by the frame 206 according to other examples. The battery assembly 210 can provide a power source for the electronics 204.

Various additional components not shown such as a core wire, stiffener or other structural component to provide structural integrity to the temple 209 are understood to be used according to some examples but are not specifically shown in FIG. 2.

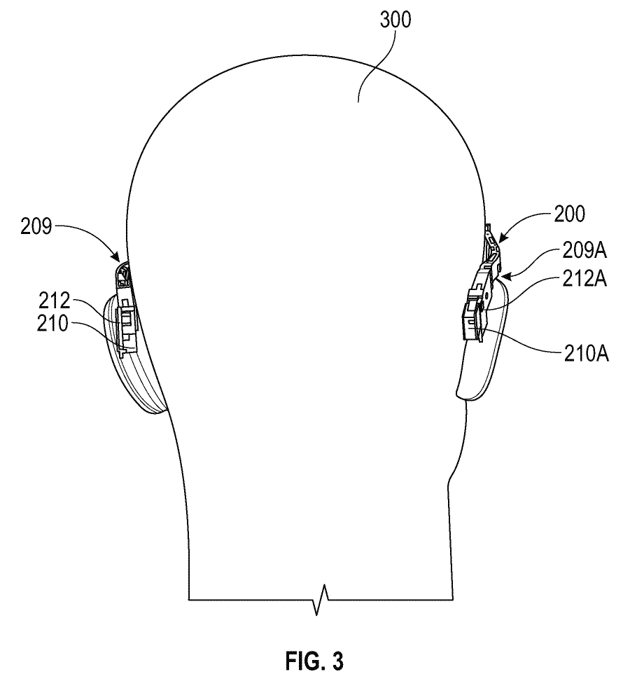

FIG. 3 illustrates a rear view with the wearable device 200 being worn by a user head 300, showing the symmetrical arrangement of components on both temples 209, 209A of the wearable device 200. The wearable device 200 as shown in FIG. 3 includes the temple 209, the second temple 209A, the battery assembly 210, a second battery assembly 210A, a hybrid antenna assembly 212 and a second hybrid antenna assembly 212A.

FIG. 3 shows the battery assembly 210 and the hybrid antenna assembly 212 at the posterior end of the temple 209 and the battery assembly 210A and the second hybrid antenna assembly 212A at the posterior end of the second temple 209A. Thus, the hybrid antenna assembly 212 can be carried by the temple 209 and can be electrically coupled to the battery assembly 210, and the second hybrid antenna assembly 212A can be carried by the second temple 209A and can be electrically coupled to the second battery assembly 210A. However, other locations are contemplated according to other exemplary examples.

The symmetrical arrangement of FIG. 3 reflects a hybrid antenna system that is implemented on both sides of the wearable device 200, with each antenna assembly 212, 212A utilizing a respective battery assembly 210, 210A as part of its operation. This configuration allows for balanced weight distribution and improved antenna performance when the device is worn on the user head 300. The hybrid antenna assembly 212 can be configured to operate at different frequencies and/or have different bandwidths as is known in the art. Furthermore, the antenna assemblies can essentially operate independent of one another. Thus, for example, the antenna assembly 212 can be configured to support at least GPS bands L1 and L5, while the second antenna assembly 212A can be configured to support at least Bluetooth band and Wi-Fi band. However, the present application contemplates that each antenna assembly 212, 212A or any of the other antennas discussed herein (or incorporated by reference) can be configured as desired to communicate at any desired range of microwave frequencies (from 300 MHz to 30 GHz).

Communication can be implemented using a wide variety of technologies. The I/O components may include communication components operable to couple the machine to a network or devices via a coupling. For example, the communication components include a network interface component or another suitable device to interface with the network. In further examples, communication components include wired communication components, wireless communication components, cellular communication components, near-field communication (NFC) components, BLUETOOTH® components (e.g., BLUETOOTH® Low Energy), WI-FI® components, and other communication components to provide communication via other modalities. The devices may be another machine or any of a wide variety of peripheral devices (e.g., a peripheral device coupled via a Universal Serial Bus (USB)).

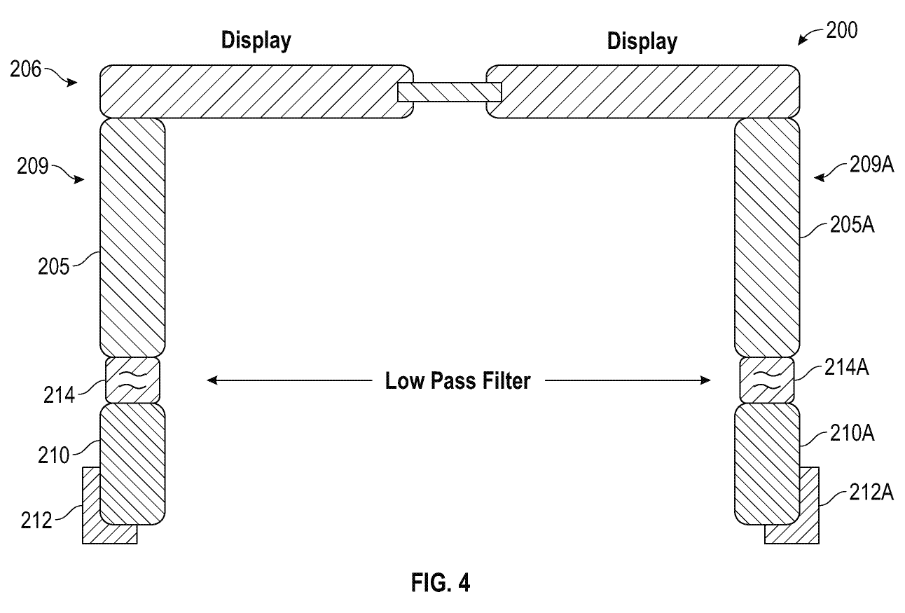

FIG. 4 is a schematic diagram of the wearable device 200 showing an example component layout and the electrical connections between the major components of the system, particularly highlighting the hybrid antenna assembly and its relationship to other electronic components including the battery assembly. FIG. 4 shows the frame 206 and the temples 209, 209A. In the example of FIG. 4, the temple 209 includes the processor 205, a low pass filter 214, the battery assembly 210 and the hybrid antenna assembly 212. The temple 209A includes the processor 205A, a second low pass filter 214A, the battery assembly 210A and the hybrid antenna assembly 212A.

FIG. 4 shows the wearable device 200 with two display units positioned at and held by the frame 206, one on each side. These displays are connected by the frame 206 to the temples 209 and 209A, which extend rearward from the frame 206.

Each temple 209, 209A can carry the processor 205 and 205A, respectively. These processors 205, 205A can be configured to handle the computing functions of the wearable device 200. As shown in FIG. 4, each temple 209, 209A can include the low pass filter 214, 214A, respectively. For temple 209, the low pass filter 214, 214A can be positioned between each processor 205, 205A and the corresponding battery assembly 210, 210A and hybrid antenna assembly 212, 212A. The low pass filter 214 is shown arranged between the processor 205 and the battery assembly 210 and the hybrid antenna assembly 212 for temple 209. For temple 209A, the second low pass filter 214A is arranged between the processor 205A and the battery assembly 210 and the hybrid antenna assembly 212A. These low pass filters 214, 214A can be configured to provide radio frequency (RF) isolation for the hybrid antenna assembly 212 and the second hybrid antenna assembly 212A from other of the electronics carried by the temples 209, 209A. The first low pass filter 214 can be configured to filter out high-frequency noise, allowing only low-frequency signals to pass through. The first low pass filter 214 is configured for RF isolation of the hybrid antenna assembly 212 from other electronic components, reducing interference and enhancing performance. Thus, as shown in FIG. 4 the hybrid antenna assembly (e.g., 212 and/or 212A) is radio frequency (RF) isolated from additional electronics (e.g., the displays, the processors 205, 205A) carried by one or both of the eyewear frame or by one of the pair of temples using a low pass filter.

FIG. 4 shows the battery assembly 210 and the hybrid antenna assembly 212 arranged at the posterior end the temple 209. The second battery assembly 210A and the second hybrid antenna assembly 212A can be arranged at the posterior end of the second temple 209A. Thus, the hybrid antenna assembly (e.g., 212 and/or 212A) and the battery assembly (210 and/or 210A) are positioned at a posterior end of the one of the pair of temples in position posterior of an ear of the user when the wearable device is worn.

The hybrid antenna assembly 212 is electrically and physically connected to the battery assembly 210. Similarly, the second hybrid antenna assembly 212A is electrically and physically connected to the second battery assembly 210A. The battery assembly 210 supplies energy to operate the electronic components within the temples 209 and 209A. The battery assembly 210 functions with the hybrid antenna assembly 212, utilizing a conductive housing of the battery assembly 210 as a return path for the loop antenna mode and as a negative pole for the dipole antenna mode. This configuration improves antenna performance while reducing space requirements.

The hybrid antenna assembly 212 facilitates multiband communication by combining loop and dipole antenna modes. It is electrically coupled to the battery assembly 210, utilizing conductive properties of the housing of the battery assembly 210 to enhance radiating behavior. The hybrid antenna assembly 212 is configured to operate efficiently across multiple frequency bands, enabling reliable data transmission and reception for AR applications. Additionally, the positioning of the hybrid antenna assembly 212 at the temple posterior end, allows for minimal interference with other electronics components and improves performance.

The second temple 209A can mirror the components and the functionality of temple 209. Thus, the temple 209A carries the processor 205A, the second low pass filter 214A, the second battery assembly 210A and the second hybrid antenna assembly 212A. The second hybrid antenna assembly 212A complements the functionality of the hybrid antenna assembly 212, providing additional multiband communication capabilities. The hybrid antenna assembly 212A can be electrically coupled to the second battery assembly 210A, leveraging the conductive properties of the battery housing to enhance radiating behavior. The configuration of FIG. 4 with multiple hybrid antenna assemblies operates efficiently across multiple frequency bands, ensuring reliable data transmission and reception for AR and other electronics based applications and functionality.

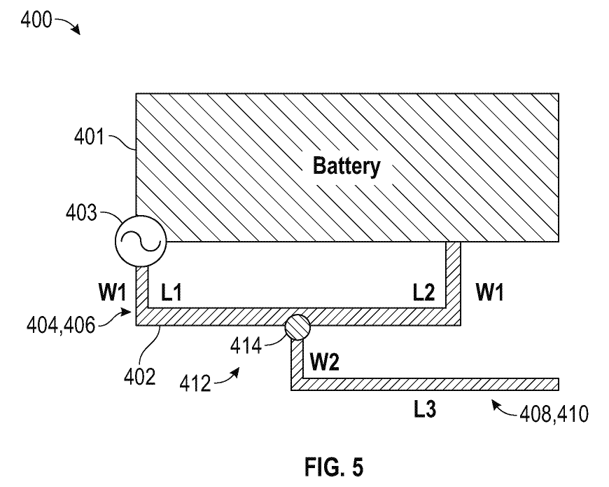

FIG. 5 is a schematic diagram of the hybrid antenna system 400 and a battery assembly 401. The system 400 can include a conductive trace 402 (sometimes just referred to as a trace), a feed point 403, a first portion 404, a loop antenna section 406, second portion 408, dipole antenna section 410, a tap point 414, and dimensional parameters including a first segment length L1, a second segment length L2, a third segment length L3, a first width W1, and a second width W2.

The hybrid antenna system 400 embodied by the hybrid antenna assembly 412 can be electrically coupled to the battery assembly 401 (particularly a housing thereof). The conductive trace 402 can form both a loop antenna section and a dipole antenna section as further discussed and illustrated herein. The trace 402 can be formed of suitable conductive metal or metal alloy material such as but not limited to one or more of copper, copper alloys, platinum, platinum alloy, aluminum, an alloy of aluminum, gold, and/or alloys of copper-nickel, nickel-silver according to some example. The trace 402 can be fabricated using advanced techniques such as laser direct sequencing or flexible printed circuit board technology, allowing for precise control over the geometry and electrical properties. The trace 402 can be designed to follow a specific path that optimizes the use of available space within the wearable device, while also ensuring effective radiation characteristics. The trace 402 interacts with the battery assembly 401 and other components to form the complete active antenna structure, enabling the hybrid antenna operation of the system 400.

The conductive trace 402 can have a feed point 403 (e.g., an excitation circuit) where the hybrid antenna system 400 is excited. The feed point 403 can serve as the primary interface for electrical signals entering the hybrid antenna system 400. Feed point 403 can be the location where the conductive trace 402 is electrically connected to the transceiver (not shown), allowing for the transmission and reception of wireless signals. The feed point 403 can be designed to couple electrical energy into the antenna structure.

From the feed point 403, the trace 402 extends to form the first portion 404 which includes the loop antenna section 406. The first portion 404 is an active antenna element. This first portion 404 has a first segment length L1 and a second segment length L2 that together with the battery assembly 401 form a loop antenna. Put another way, the first portion includes a first segment length (L1) and a second segment length (L2) that together with the battery assembly are configured to operate in a loop antenna mode. The first portion 404 of the trace 402 is a segment that contributes to the formation of the loop antenna section 406. The first portion 404 can be designed to have a specific physical length (e.g., first segment length (L1) and second segment length (L2)) and width, which can be parameters that influence the resonant frequency and bandwidth of the loop antenna. The first portion 404 can be positioned around the battery assembly 401, utilizing the conductive properties of the battery assembly 401 to enhance the performance of the loop antenna. Design of the first portion 404, forming the loop antenna section 406 can achieve efficient radiation patterns and support multiple frequency bands, complementing the dipole antenna section 410.

The second portion 408 of the conductive trace includes the dipole antenna section 410 with a third segment length L3 that extends from the tap point 414 on the first portion 404. The second portion 408 is an active antenna element. Thus, the second portion 408 includes the third segment length (L3) that extends from the tap point 414 on the loop antenna section 406 that is formed by the first portion 404 of the trace 402. The third segment length (L3) in combination with the first segment length (L1) are configured to operate in a dipole antenna mode. Lengths L1, L2 and L3 contribute to the resonant frequencies of the respective antenna sections.

FIG. 5 additionally shows widths W1 and W2 that influence the bandwidth of the hybrid antenna system 400 as a spacing width between the loop antenna section 406 and the battery assembly 401 and between the dipole antenna section 410 and the loop antenna section 406 can be configured to control an amount of bandwidth of the hybrid antenna system 400.

Placement of the tap point 414 on the first portion can enable both the loop antenna and dipole antenna to operate without substantial interference between their respective resonant frequencies. The tap point 414 can be a junction within the hybrid antenna system 400, where the dipole antenna section 410 is electrically connected to the loop antenna section 406. The tap point 414 can be positioned to enable both antenna sections to operate without substantial interference, allowing for simultaneous support of multiple frequency bands. The tap point 414 can be designed to optimize the impedance matching between the two antenna sections, ensuring efficient energy transfer and minimal signal loss. Thus, by selecting the location of the tap point 414, the hybrid antenna system 400 can achieve a balanced performance across the operational frequency range.

The tap point location plays a role in the performance and functionality of the hybrid antenna system. The precise positioning of the tap point enables independent operation of both antenna modes without mutual interference by creating distinct current paths for the loop and dipole modes. This separation allows the antenna to maintain separate resonant frequencies, which is important for supporting multiple frequency bands simultaneously, such as WiFi 6E's 2.4 GHz, 5 GHz, and 6 GHz bands. The tap point location can directly influence the impedance matching between the loop and dipole antenna sections. When properly positioned, the tap point minimizes signal reflections and maximizes power transfer efficiency. This positioning affects the voltage standing wave ratio (VSWR), as demonstrated in performance measurements showing efficient operation across multiple frequency bands. The tap point's location determines how electrical current is distributed between the loop and dipole sections, which in turn affects the radiation patterns and efficiency of both antenna modes. The physical length relationships between segments (L1, L2, and L3) relative to the tap point are carefully designed to maintain proper current distribution throughout the antenna system. Working in conjunction with spacing widths (W1 and W2), the tap point position influences the overall bandwidth capability of the hybrid antenna assembly. Strategic placement enables the antenna to maintain consistent performance across wide frequency ranges, helping achieve the smooth and low VSWR values observed in the 5-7 GHz range. Finally, the tap point serves as a junction for controlling the coupling between the loop and dipole modes. Its proper placement ensures that each mode can operate effectively while maintaining electrical isolation, which is essential for achieving multiband performance without compromising the efficiency of either antenna mode. This careful positioning allows the hybrid antenna system to achieve balanced performance across its entire operational frequency range.

The hybrid antenna system 400 can be designed to enhance the performance of wearable devices by integrating both dipole and loop antenna functionalities. The hybrid antenna system 400 is engineered to operate efficiently across multiple frequency bands, thereby facilitating improved data transmission and reception capabilities. By combining the characteristics of both dipole and loop antennas, the hybrid antenna system 400 achieves a balance between compact design and high-performance radiation patterns, which is important for the limited space available in wearable devices.

The dipole antenna section 410 can play a role in the hybrid antenna system 400, responsible for generating electric fields that are orthogonal to the direction of propagation. This section is designed to operate in a TM₁₀ mode, which is characteristic of dipole antennas. The dipole antenna section 410 can be implemented by extending the trace 402 from the tap point 414, forming a linear structure that interacts with the loop antenna section 406. The length of the dipole antenna section 410 can be configured to resonate at specific frequencies, contributing to the multiband capabilities of the hybrid antenna system 400. The dipole antenna section 410 can be positioned to minimize interference with other electronic components within the wearable device, ensuring desired performance.

The loop antenna section 406 can be responsible for generating magnetic fields that are orthogonal to the direction of propagation. The loop antenna section 406 operates in the TE₁₀ mode, characteristic of loop antennas, and is formed by the first portion 404 of the trace 402 with the battery assembly 401. The loop antenna section 406 can be configured to have a perimeter length that resonates at specific frequencies, contributing to the multiband capabilities of the hybrid antenna system 400. The loop antenna section 406 can be integrated with the battery assembly 401, allowing for efficient use of space and enhanced radiation performance.

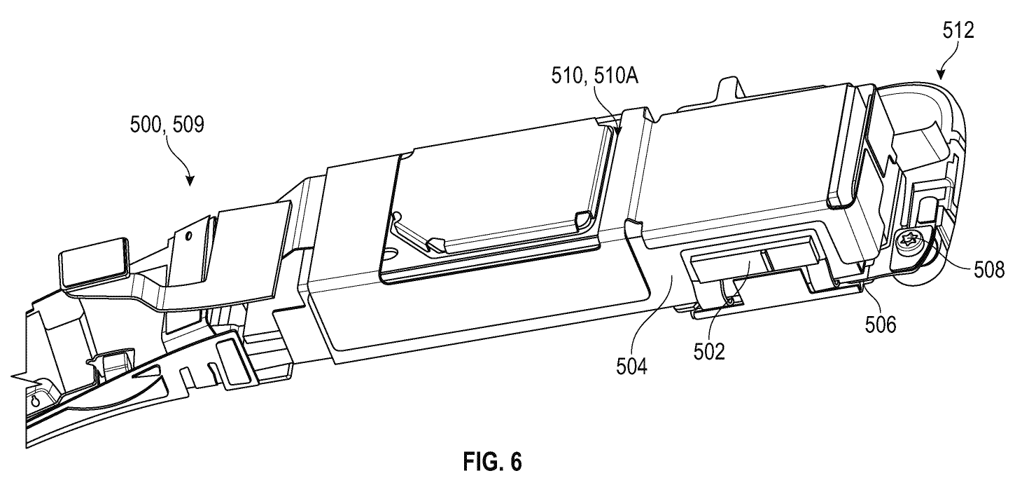

FIG. 6 is a perspective view of a wearable device 500, in particular a temple 509 thereof with a cover removed. The temple 509 can includes a chipset 502, a first side 504 of a battery assembly 510, a battery housing 510A (referred to herein as a housing herein), a hybrid antenna assembly 512, a fastener 508, and a transceiver 506.

FIG. 6 shows the temple 509 at a rear (posterior portion) thereof where the battery assembly 510 and the hybrid antenna assembly 512 can be located according to one example. As shown in FIG. 6, the transceiver 506 can be electrically connected to the battery assembly 510 on the first side (not shown in FIG. 6 but shown in other subsequent FIGURES, and the chipset 502 can be positioned on a second side (the first side 504 of FIG. 6) of the battery assembly 510. This arrangement allows the chipset 502 to be spaced from the transceiver 506.

As shown in FIG. 6, the hybrid antenna assembly 512 is electrically connected to the battery housing 510A, and hence, the battery assembly 510. The fastener 508 electrically connects the chipset 502 and/or the transceiver 506 to the hybrid antenna assembly 512. The fastener 508 can be designed to ensure a secure and reliable electrical connection, minimizing the risk of signal loss or interference. The fastener 508 can be positioned to connect the chipset 502 to the hybrid antenna assembly 512, allowing for the efficient transfer of signals. This mechanical fastener, often a screw, provides a robust connection that is less prone to failure compared to other connection methods, such as coaxial cables or spring contacts. However, such other connection mechanisms (coaxial cable, spring contact, etc.) are contemplated according to other examples.

The chipset 502 can operate as the processing unit for the hybrid antenna assembly 512. The chipset 502 can manage the data processing and communication tasks necessary for the device’s operation. The chipset 502 can electronically interact with the transceiver 506 to facilitate the transmission and reception of wireless signals. The chipset 502 can be designed to handle signal processing tasks, ensuring efficient communication between the device and external networks.

The transceiver 506 can be responsible for enabling wireless communication. The transceiver 506 can be electrically connected to the battery assembly 510 and can work in conjunction with the chipset 502 to manage the transmission and reception of signals. The transceiver 506 can be designed to operate across multiple frequency bands, supporting the multiband hybrid antenna system.

The housing 510A can be constructed from an electrically conductive material, which is used as part of the hybrid antenna system. This design enables the battery assembly 510 to fulfill a dual role, supplying power while also contributing to the antenna’s functionality. The housing 510A can be designed to be RF isolated from the rest of the device (some examples) in other examples the hybrid antenna assembly 512 can be enclosed by a housing (not shown) that is designed to be RF isolating from the rest of the device.

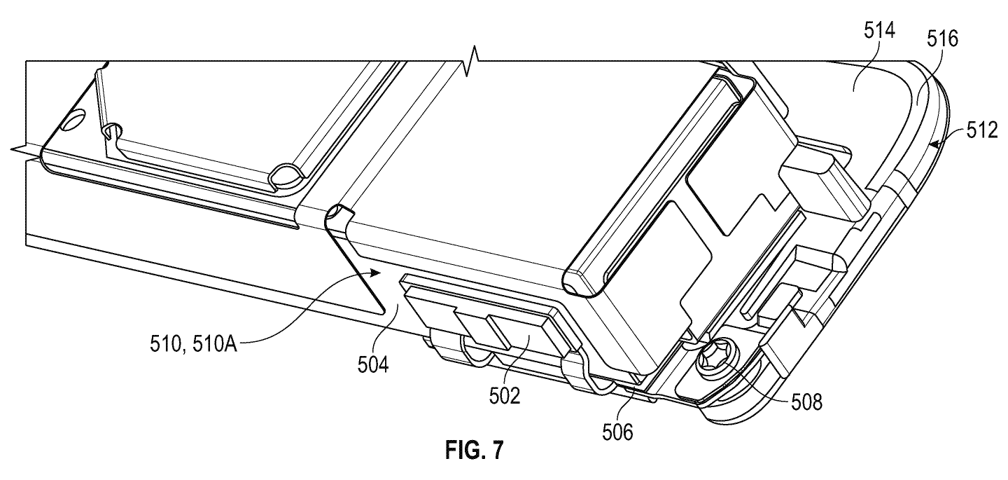

FIG. 7 is an enlarged view of the temple of the wearable device of FIG. 6. FIG. 7 illustrates the chipset 502, the first side 504 of the battery assembly 510, the battery housing 510A, the hybrid antenna assembly 512, the fastener 508, and the transceiver 506 as previously discussed in FIG. 6, and additionally illustrates a carrier 514 and a conductive trace 516.

The carrier 514 can be constructed in an electrically insulating material (e.g., plastic) and can be configured to support the conductive trace 516 that forms the hybrid antenna assembly 512. The carrier 514 can function as a substrate for the conductive trace 516, which is part of the hybrid antenna assembly 512. The carrier 514 if made from a plastic material, can be lightweight and can allow for flexibility in shaping the antenna trace 516. Carrier 514 can be coupled to the battery assembly 510 and/or to other portions of the temple.

The conductive trace 516 can be formed on the carrier 514 using techniques such as laser direct sequencing, which involves depositing metal onto the plastic substrate to create the desired antenna pattern. This fabrication method enables precise control over the dimensions of the trace 516. The trace 516 as shown is designed to support both the loop and dipole antenna modes, leveraging the conductive properties to facilitate efficient signal transmission and reception. The dimensions of the trace 516, including length and width, play a role in determining the antenna's frequency of operation and bandwidth capabilities as discussed previously.

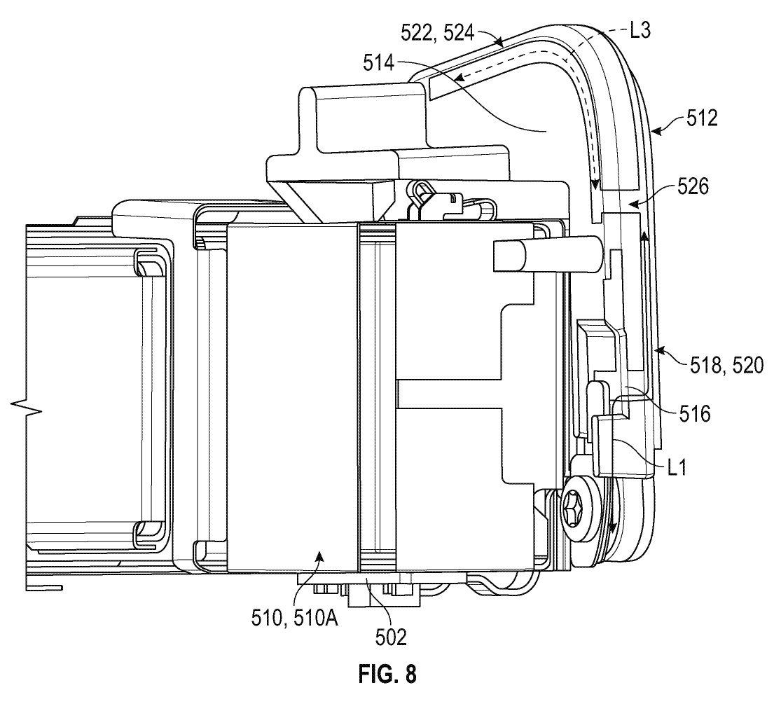

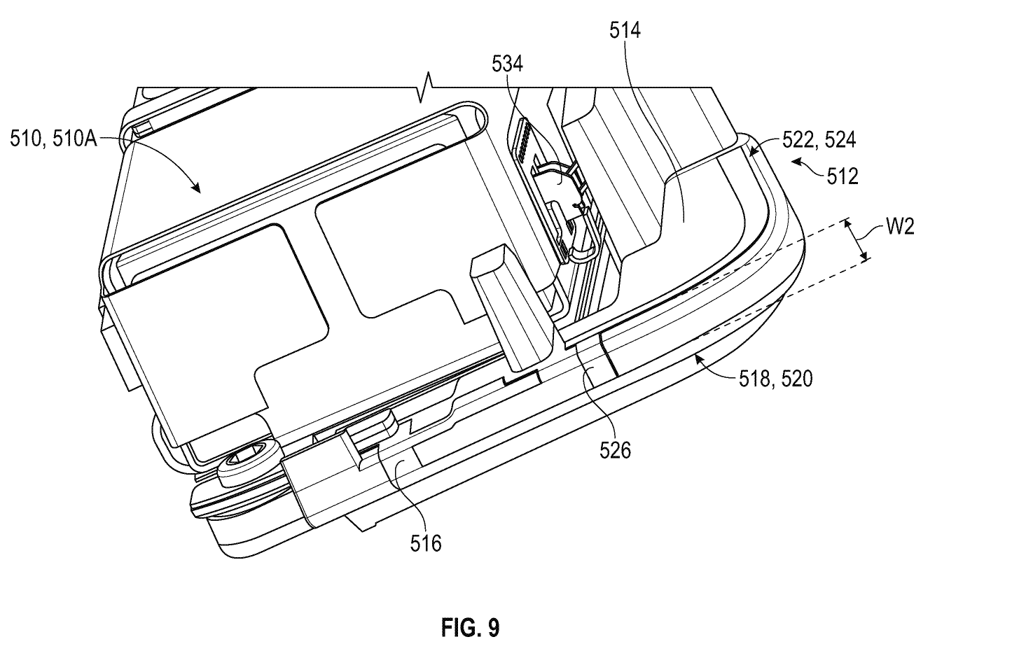

FIGS. 8 and 9 illustrate further features of the wearable device and temple previously shown in FIGS. 6 and 7. FIGS. 8 and 9 show the battery assembly 510, the battery housing 510A, the hybrid antenna assembly 512, the carrier 514 and the conductive trace 516 as previously discussed. FIGS. 8 and 9 additionally show a first portion 518, a loop antenna section 520, a second portion 522, a dipole antenna section 524 and a tap point 526. FIG. 8 additionally identifies a first segment length L1 and a third segment length L3. FIG. 9 additionally identifies a second width W2 and a spring contact 534.

FIGS. 8 and 9 show the hybrid antenna assembly 512 mounted on the carrier 514 that extends around the battery assembly 510. The conductive trace 516 forms the first portion 518 and the second portion 522. The first portion 518 forms the loop antenna section 520. The second portion 522 forms the dipole antenna section 524, which extends from the first portion 518 (the loop antenna section 520) at the tap point 526. Tap point 526 is a location on the conductive trace 516 where the dipole antenna section 524 connects to the loop antenna section 520.

Discussion of the construction and function of the first portion, loop antenna section, second portion, dipole antenna section and the tap point was previously discussed in related example of FIG. 5, and thus, will not be repeated herein.

Turning to FIG. 9, the spring contact 534 can provide a DC short between the conductive trace 516 and the battery housing 510A, facilitating the loop antenna mode’s operation. This connection via the spring contact 534 (or alternatively via a mechanical fastener such as the example previously described) allows the loop antenna section 520 to have a stable return path. The second width W2 is a parameter that influences the bandwidth of the dipole mode in the hybrid antenna assembly 512. By adjusting W2, the bandwidth of the dipole mode can be tuned to better meet specific performance requirements.

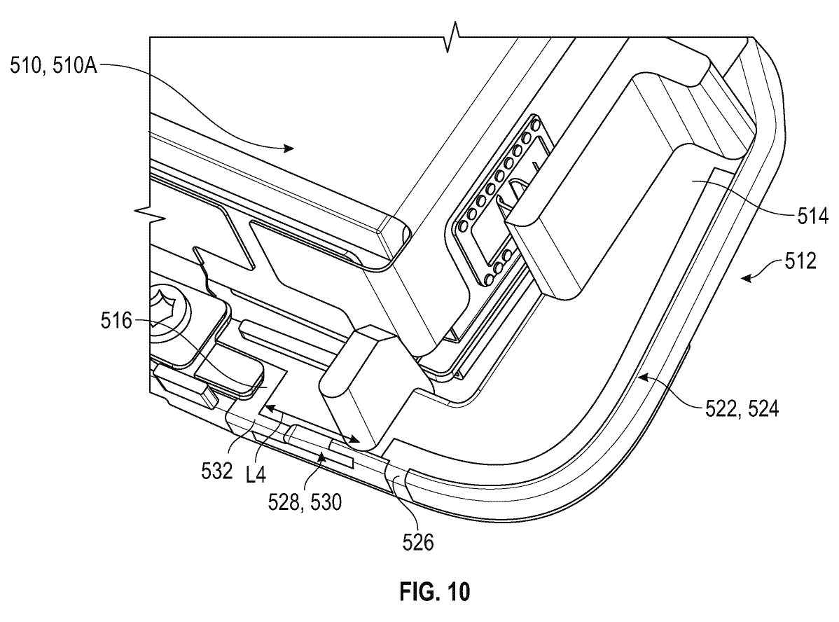

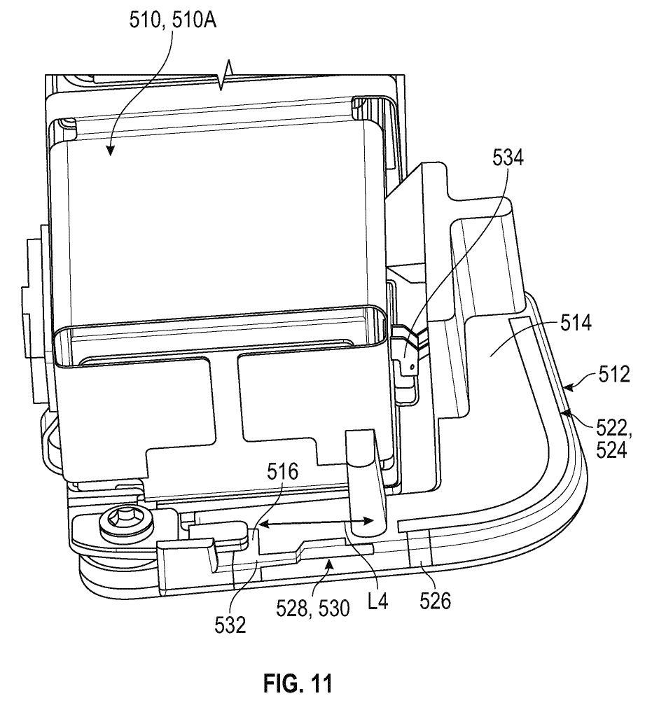

FIGS. 10 and 11 show further views of the hybrid antenna assembly 512 and portions of the battery assembly 510 including portions of the housing 510A from various perspectives. FIGS. 10 and 11 show the carrier 514, the conductive trace 516, the second portion 522, the dipole antenna section 524, the tap point 526 and the spring contact 534 (FIG. 9) as previously discussed. FIGS. 10 and 11 additionally show a third portion 528, a second dipole antenna section 530, a second tap point 532 and fourth segment length L4.

While the second portion 522 forms the dipole antenna section 524 discussed previously, the example of FIGS. 10 and 11 additionally show the third portion 528 that is the second dipole antenna section 530. The third portion 528 is an active antenna element. The conductive trace 516 includes the fourth segment length L4 extending from the second tap point 532 with the first portion. The fourth segment length L4 can be shorter than (as shown in FIGS. 10 and 11) or longer than the third segment length L3 to provide an additional dipole antenna mode at one of a higher resonant frequency or a lower resonant frequency. Therefore, the third portion 528 of the second dipole antenna section 530 are configured to form an additional dipole antenna mode within the hybrid antenna assembly 512. The third portion 528 is configured to provide supplementary resonant frequencies, enhancing bandwidth and supporting additional communication standards. The length (fourth segment length L4) and configuration can be configured to achieve specific frequency responses, allowing the hybrid antenna assembly 412 to operate more effectively in diverse wireless environments. The third portion 528 can interact with the other components of the hybrid antenna assembly 512 to ensure seamless integration and performance.

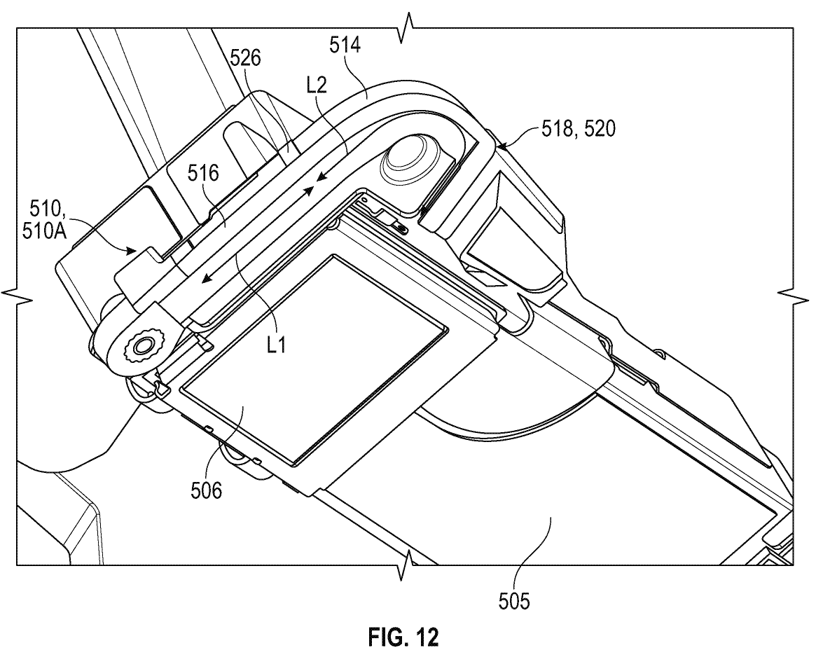

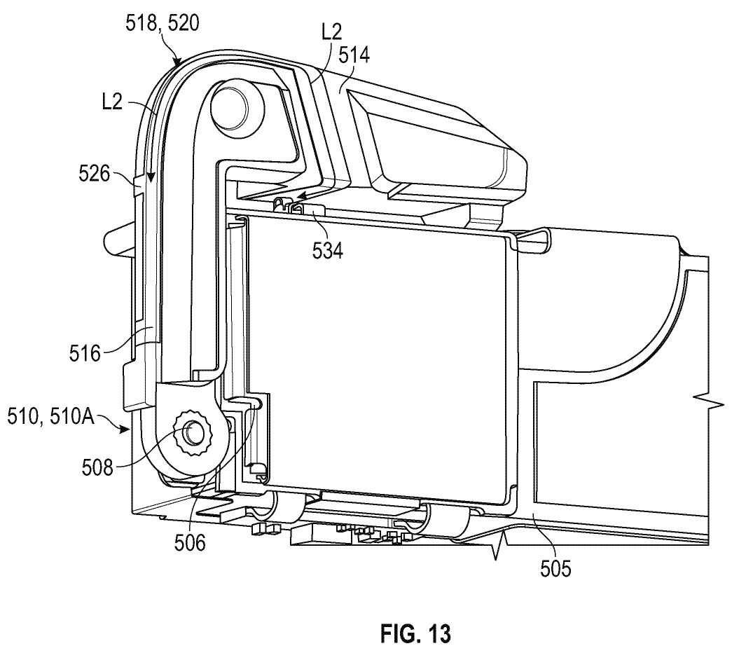

FIGS. 12 and 13 illustrate a second side 505 of the battery assembly 510 and the hybrid antenna assembly 512. FIGS. 12 and 13 shows the hybrid antenna assembly 512 and the electrical and mechanical connection of the hybrid antenna assembly 512 to the battery assembly 510 including the housing 510A. FIGS. 12 and 13 additionally show the carrier 514, the conductive trace 516, the first portion, 518, the loop antenna section 520, the tap point 526, the transceiver 506, spring contact 534 (FIG. 13), and the fastener 508 (FIG. 13) as previously discussed.

FIGS. 12 and 13 better illustrate the transceiver 506 positioned on (and optionally electrically connected to) the second side 505 of the battery assembly 510. As shown in FIG. 13, the transceiver 506 can be protected by a cover. The transceiver 506 can be electrically connected to the hybrid antenna assembly 512 by the fastener 508 (FIG. 13) as previously discussed.

FIGS. 12 and 13 additionally show the second segment length L2 of the trace 516 that forms part of the loop antenna section 520 (additionally part of the first portion 518 of the trace 516) that extends from the tap point 526 back to the electrical connection with the battery assembly 510 (e.g., via the spring contact 534 shown in FIG. 13). FIG. 12 additionally labels the first segment length L1 of the trace 516 that forms part of loop antenna section 520 (additionally part of the first portion 518 of the trace 516). As shown in FIGS. 12 and 13, the loop antenna section 520 particularly along the second segment length L2 can have an arcuate curvature for a portion thereof from the tap point 526 followed by an abrupt change in orientation to return toward the battery assembly 510.

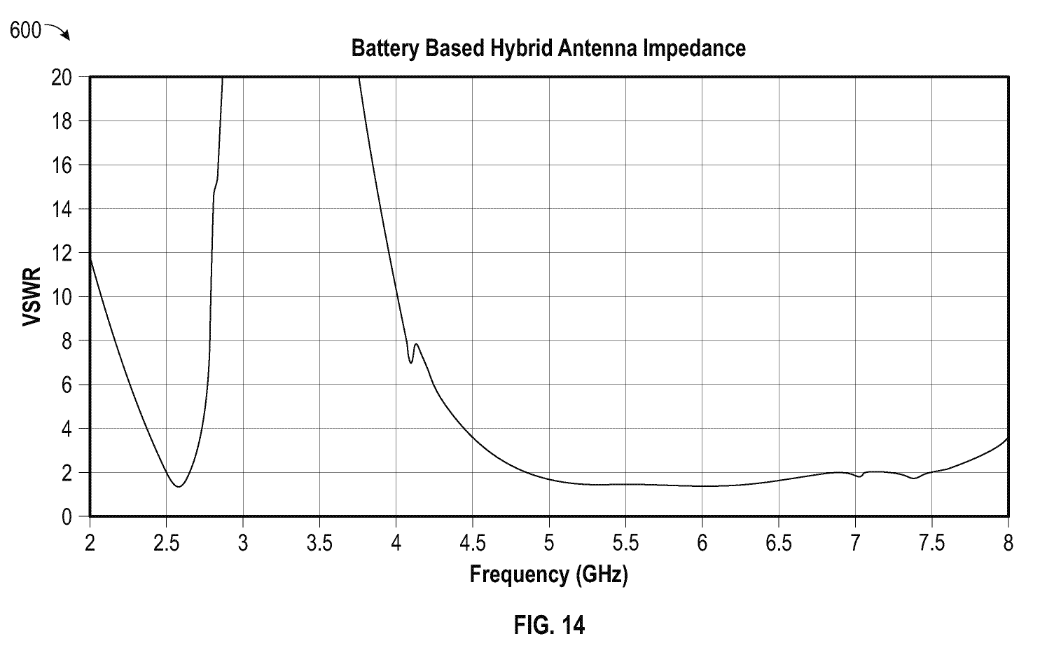

FIG. 14 illustrates a chart 600 showing the impedance response of the hybrid antenna assembly implemented in the wearable device as shown in FIGS. 6-13. The chart 600 displays the Voltage Standing Wave Ratio (VSWR) on the y-axis, ranging from 0 to 20, plotted against Frequency (GHz) on the x-axis, ranging from 2 GHz to 8 GHz.

The chart 600 shows multiple resonant frequencies where the VSWR dips, indicating efficient antenna operation at those specific frequencies. There is a dip around 2.4-2.5 GHz, which corresponds to the dipole mode operation of the antenna. Another region of lower VSWR appears across the 5-7 GHz range, which represents the loop mode operation. The chart 600 demonstrates the multiband capability of the hybrid antenna assembly previously shown and described, showing how the antenna effectively operates across the WiFi frequency bands (2.4 GHz, 5 GHz, and 6 GHz). The relatively smooth and low VSWR values in the 5-7 GHz range indicate that the antenna has been well-tuned to provide consistent performance across these higher frequency bands.

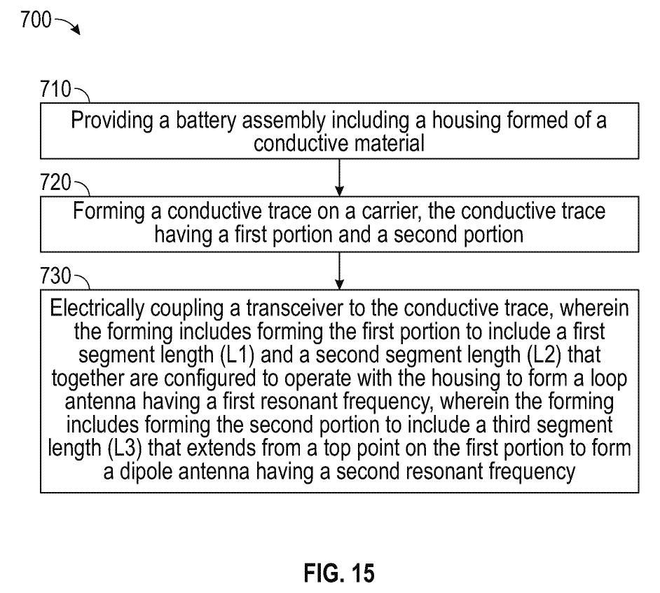

FIG. 15 is a flow chart of a method 700 of forming a multiband hybrid antenna assembly for a wearable device (e.g., such as the eyewear device previously described herein). The method 700 can include a step 710 of providing a battery assembly including a housing formed of a conductive material. The method 700 can include a step 720 of forming a conductive trace on a carrier, the conductive trace having a first portion and a second portion. The method 700 can include a step 730 of electrically coupling a transceiver to the conductive trace. The step 720 can optionally include that the forming includes forming the first portion to include a first segment length (L1) and a second segment length (L2) that together are configured to operate with the housing to form a loop antenna having a first resonant frequency. The step 720 can optionally include that the forming includes forming the second portion to include a third segment length (L3) that extends from a tap point on the first portion to form a dipole antenna having a second resonant frequency. The step 720 can optionally include that the forming the conductive trace on the carrier uses one of: laser direct sequencing, manipulating a flexible printed circuit board, or insert molding. The method 700 can optionally include arranging a spring contact with the first portion of the conductive trace such that the conductive trace is DC shorted to the housing via the spring contact.

As used herein machine-readable medium is non-transitory (in other words, not having any transitory signals) in that it does not embody a propagating signal. However, labeling the machine-readable medium “non-transitory” should not be construed to mean that the medium is incapable of movement; the medium should be considered as being transportable from one physical location to another. Additionally, since the machine-readable medium is tangible, the medium may be considered to be a machine-readable device.

Note that although the disclosure herein of a device that incorporates antenna systems, as disclosed, is directed primarily to the example of an eyewear device, antenna systems as disclosed may in other examples be incorporated in different types of electronic devices. Thus, for example, the disclosed antenna systems can be profitably employed in other wearable electronic devices, mobile electronic devices (such as mobile phones, tablets, or the like), and/or larger products such as motor vehicles or the like.

The foregoing description includes devices, systems techniques, instruction sequences, and computing machine program products that embody illustrative examples of the disclosure. In the above description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example, various modifications and changes may be made to these examples without departing from the broader scope of examples of the present disclosure. Such examples of the inventive subject matter may be referred to herein, individually or collectively, by the term “invention” merely for convenience and without intending to voluntarily limit the scope of this application to any single disclosure or inventive concept if more than one is, in fact, disclosed.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. The specification and drawings are, accordingly, to be regarded in an illustrative rather than a restrictive sense.

The following numbered examples is a non-exhaustive list of selected illustrative examples in accordance with various aspects of the present disclosure.

### CLAIMS RELATED EXAMPLES

In Example 1 is a wearable device optionally comprising: an eyewear frame defining one or more optical element holders for holding respective optical elements within view of a user when the wearable device is worn; a pair of temples connected to the eyewear frame for supporting the eyewear frame in position within view of the user when the wearable device is worn; a battery assembly carried by at least one of the eyewear frame or by one of the pair of temples; and a hybrid antenna assembly electrically coupled to the battery assembly, the hybrid antenna assembly having a conductive trace with a first portion forming a loop antenna section and a second portion forming a dipole antenna section; the dipole antenna section being electrically connected to the loop antenna section at a tap point.

In Example 2, the subject matter of Example 1 optionally includes, wherein the first portion includes a first segment length (L1) and a second segment length (L2) that together with the battery assembly are configured to operate in a loop antenna mode.

In Example 3, the subject matter of Example 2 optionally includes, wherein the second portion includes a third segment length (L3) that extends from the tap point on the loop antenna section, wherein the third segment length (L3) in combination with the first segment length (L1) are configured to operate in a dipole antenna mode.

In Example 4, the subject matter of Example 3 optionally includes, wherein at least one of the first segment length (L1) or the second segment length (L2) has substantially a same physical length as the third segment length (L3).

In Example 5, the subject matter of Example 4 optionally includes, wherein the at least one of the first segment length (L1) and the second segment length (L2) have a length that differ from one another by a multiple of a fraction of a wavelength of a fundamental operating frequency of the hybrid antenna assembly.

In Example 6, the subject matter of Example 5 optionally includes, wherein the conductive trace further optionally includes a fourth segment length (L4) extending from a second tap point with the first portion, wherein the fourth segment length (L4) is shorter than or longer than the third segment length (L3) to provide an additional dipole antenna mode at one of a higher resonant frequency or a lower resonant frequency.

In Example 7, the subject matter of Examples 1–6 optionally includes, wherein a physical length of the loop antenna section is substantially similar to a physical length of the dipole antenna section, wherein a spacing width between the loop antenna section and the battery and between the dipole antenna section and the loop antenna section is configured to control an amount of bandwidth of the hybrid antenna assembly.

In Example 8, the subject matter of Examples 1–7 optionally includes, wherein the conductive trace is formed on a carrier that extends around at least two sides of the battery assembly.

In Example 9, the subject matter of Examples 1–8 optionally includes, a transceiver electrically connected to the battery assembly on a first side thereof; a chipset positioned on a second side of the battery assembly spaced from the transceiver.

In Example 10, the subject matter of Example 9 optionally includes, one of a spring connection or a mechanical fastener that electrically connects the hybrid antenna assembly to the transceiver.

In Example 11, the subject matter of Examples 1–10 optionally includes, wherein the first portion of the conductive trace is DC shorted to the battery assembly via one of a spring contact or a mechanical fastener.

In Example 12, the subject matter of Examples 1–11 optionally includes, wherein the hybrid antenna assembly and the battery assembly are positioned at a posterior end of the one of the pair of temples in position posterior of an ear of the user when the wearable device is worn.

In Example 13, the subject matter of Examples 1–12 optionally includes, wherein the hybrid antenna assembly is radio frequency (RF) isolated from additional electronics carried by one or both of the eyewear frame or by one of the pair of temples using a low pass filter.

Example 14 is a multiband hybrid antenna system for a wearable electronic device, the system optionally comprising: a battery assembly including a housing formed of an electrically conductive material; a conductive trace having a first portion and a second portion; and a transceiver electrically coupled to the conductive trace; wherein the first portion includes, a first segment length (L1) and a second segment length (L2) that together with the housing form a loop antenna having a first resonant frequency; wherein the second portion includes a third segment length (L3) that extends from a tap point on the first portion to form a dipole antenna having a second resonant frequency; were the transceiver is configured to transmit and receive wireless signals via the loop antenna and the dipole antenna.

In Example 15, the subject matter of Example 14 optionally includes, wherein the tap point is positioned at a location on the first portion to enable both the loop antenna and the dipole antenna to operate without substantial interference between the first resonant frequency and the second resonant frequency.

In Example 16, the subject matter of Examples 14–15 optionally includes, wherein the conductive trace further includes a fourth segment length (L4) extending from a second tap point with the first portion, wherein the fourth segment length is shorter than or longer than the third segment length (L3) to provide an additional dipole antenna mode at one of a higher resonant frequency or a lower resonant frequency.

In Example 17, the subject matter of Examples 14–16 optionally includes, wherein at least one of the first segment length (L1) or the second segment length (L2) has substantially a same physical length as the third segment length (L3).

In Example 18, the subject matter of Examples 14–17 optionally includes, an electrically insulating carrier that extends around at least two sides of the battery assembly, wherein the electrically insulating carrier has the conductive trace formed thereon; and a chipset positioned on a second side of the battery assembly spaced from the transceiver.

Example 19 is a method of forming a multiband hybrid antenna assembly for a wearable device, the method optionally comprising: providing a battery assembly including a housing formed of a conductive material; forming a conductive trace on a carrier, the conductive trace having a first portion and a second portion; and electrically coupling a transceiver to the conductive trace; wherein the forming includes, forming the first portion to include a first segment length (L1) and a second segment length (L2) that together are configured to operate with the housing to form a loop antenna having a first resonant frequency; wherein the forming includes forming the second portion to include a third segment length (L3) that extends from a tap point on the first portion to form a dipole antenna having a second resonant frequency.

In Example 20, the subject matter of Example 19 optionally includes, wherein forming the conductive trace on the carrier uses one of: laser direct sequencing, manipulating a flexible printed circuit board, or insert molding.

In Example 21, the subject matter of Examples 19–20 optionally includes, arranging one of a spring contact or a mechanical fastener with the first portion of the conductive trace such that the conductive trace is DC shorted to the housing via the spring contact.

Example 22 is at least one machine-readable medium including instructions that, when executed by processing circuitry, cause the processing circuitry to perform operations to implement of any of Examples 1–21.

Example 23 is an apparatus comprising means to implement of any of Examples 1–21.

Example 24 is a system to implement of any of Examples 1–21.

Example 25 is a method to implement of any of Examples 1–21.

Example 26 is any combination of elements from Examples 1-21.

What is claimed is:

1. A wearable device comprising:
an eyewear frame defining one or more optical element holders for holding respective optical elements within view of a user when the wearable device is worn;
a pair of temples connected to the eyewear frame for supporting the eyewear frame in position within view of the user when the wearable device is worn;
a battery assembly carried by at least one of the eyewear frame or by one of the pair of temples; and
a hybrid antenna assembly electrically coupled to the battery assembly, the hybrid antenna assembly having a conductive trace with a first portion forming a loop antenna section and a second portion forming a dipole antenna section;
the dipole antenna section being electrically connected to the loop antenna section at a tap point.

2. The wearable device of claim 1, wherein the first portion includes a first segment length (L1) and a second segment length (L2) that together with the battery assembly are configured to operate in a loop antenna mode.

3. The wearable device of claim 2, wherein the second portion includes a third segment length (L3) that extends from the tap point on the loop antenna section, wherein the third segment length (L3) in combination with the first segment length (L1) are configured to operate in a dipole antenna mode.

4. The wearable device of claim 3, wherein at least one of the first segment length (L1) or the second segment length (L2) has substantially a same physical length as the third segment length (L3).

5. The wearable device of claim 4, wherein the at least one of the first segment length (L1) and the second segment length (L2) have a length that differ from one another by a multiple of a fraction of a wavelength of a fundamental operating frequency of the hybrid antenna assembly.

6. The wearable device of claim 5, wherein the conductive trace further includes a fourth segment length (L4) extending from a second tap point with the first portion, wherein the fourth segment length (L4) is shorter than or longer than the third segment length (L3) to provide an additional dipole antenna mode at one of a higher resonant frequency or a lower resonant frequency.

7. The wearable device of claim 1, wherein a physical length of the loop antenna section is substantially similar to a physical length of the dipole antenna section, wherein a spacing width between the loop antenna section and the battery and between the dipole antenna section and the loop antenna section is configured to control an amount of bandwidth of the hybrid antenna assembly.

8. The wearable device of claim 1, wherein the conductive trace is formed on a carrier that extends around at least two sides of the battery assembly.

9. The wearable device of claim 1, further comprising:
a transceiver electrically connected to the battery assembly on a first side thereof;
a chipset positioned on a second side of the battery assembly spaced from the transceiver.

10. The wearable device of claim 9, further comprising one of a spring connection or a mechanical fastener that electrically connects the hybrid antenna assembly to the transceiver.

11. The wearable device of claim 1, wherein the first portion of the conductive trace is DC shorted to the battery assembly via one of a spring contact or a mechanical fastener.

12. The wearable device of claim 1, wherein the hybrid antenna assembly and the battery assembly are positioned at a posterior end of the one of the pair of temples in position posterior of an ear of the user when the wearable device is worn.

13. The wearable device of claim 1, wherein the hybrid antenna assembly is radio frequency (RF) isolated from additional electronics carried by one or both of the eyewear frame or by one of the pair of temples using a low pass filter.

14. A multiband hybrid antenna system for a wearable electronic device, the system comprising:
a battery assembly including a housing formed of an electrically conductive material;
a conductive trace having a first portion and a second portion; and
a transceiver electrically coupled to the conductive trace;
wherein the first portion includes a first segment length (L1) and a second segment length (L2) that together with the housing form a loop antenna having a first resonant frequency;
wherein the second portion includes a third segment length (L3) that extends from a tap point on the first portion to form a dipole antenna having a second resonant frequency;
were the transceiver is configured to transmit and receive wireless signals via the loop antenna and the dipole antenna.

15. The multiband hybrid antenna system of claim 14, wherein the tap point is positioned at a location on the first portion to enable both the loop antenna and the dipole antenna to operate without substantial interference between the first resonant frequency and the second resonant frequency.

16. The multiband hybrid antenna system of claim 14, wherein the conductive trace further includes a fourth segment length (L4) extending from a second tap point with the first portion, wherein the fourth segment length is shorter than or longer than the third segment length (L3) to provide an additional dipole antenna mode at one of a higher resonant frequency or a lower resonant frequency.

17. The multiband hybrid antenna system of claim 14, wherein at least one of the first segment length (L1) or the second segment length (L2) has substantially a same physical length as the third segment length (L3).

18. The multiband hybrid antenna system of claim 14, further comprising:
an electrically insulating carrier that extends around at least two sides of the battery assembly, wherein the electrically insulating carrier has the conductive trace formed thereon; and
a chipset positioned on a second side of the battery assembly spaced from the transceiver.

19. A method of forming a multiband hybrid antenna assembly for a wearable device, the method comprising:
providing a battery assembly including a housing formed of a conductive material;
forming a conductive trace on a carrier, the conductive trace having a first portion and a second portion; and
electrically coupling a transceiver to the conductive trace;
wherein the forming includes forming the first portion to include a first segment length (L1) and a second segment length (L2) that together are configured to operate with the housing to form a loop antenna having a first resonant frequency;
wherein the forming includes forming the second portion to include a third segment length (L3) that extends from a tap point on the first portion to form a dipole antenna having a second resonant frequency.

20. The method of claim 19, wherein forming the conductive trace on the carrier uses one of: laser direct sequencing, manipulating a flexible printed circuit board, or insert molding, and arranging one of a spring contact or a mechanical fastener with the first portion of the conductive trace such that the conductive trace is DC shorted to the housing via the spring contact.
